(19) United States
(12) Patent Application Publication
(10) Pub. No.: US 2024/0262988 A1
(43) Pub. Date: Aug. 8, 2024

(54) HIGH SOLIDS CELLULOSE ETHER AND SUPERPLASTICIZER DISPERSION

(71) Applicants: Rohm and Haas Company, Collegeville, PA (US); Dow Global Technologies LLC, Midland, MI (US)

(72) Inventors: Jessica R. Levin, Collegeville, PA (US); Michael J. Radler, Saginaw, MI (US); Yi Fan, Lake Jackson, TX (US)

(21) Appl. No.: 18/566,693

(22) PCT Filed: Jul. 27, 2022
(86) PCT No.: PCT/US2022/038482

§ 371 Date: Dec. 4, 2023

Related U.S. Application Data
(60) Provisional application No. 63/231,356, filed on Aug. 10, 2021.

(51) Int. Cl. C08L 1/28; C08K 5/092

(52) U.S. Cl. CPC C08L 1/284; C08K 5/092; C08L 2201/54

(57) ABSTRACT

The present invention provides pourable aqueous dispersion compositions of (a) one or more cellulose ethers and (b) one or more superplasticizers stably suspended in an aqueous dispersion of (c) one or more stabilizers in the form of a colloidal dispersion, further containing (d) one or more monovalent salts, such as an alkali metal salt. The minimum total amount of the cellulose ether, as solids in the pourable aqueous dispersion is 8 wt. % or, preferably, 12 wt. % or, preferably, 14 wt. % and the solids weight ratio of total cellulose ether to salt is close to 1:1, ranging, for example, from 0.7:1 to 1.4:1. Further, the amounts of the (a) one or more cellulose ethers and the (b) one or more superplasticizers enable the provision of pourable aqueous dispersion compositions effective for use in cement applications by simple dilution with water.

The present invention relates to pourable aqueous dispersion compositions comprising (a) one or more cellulose ethers and (b) one or more superplasticizers dispersed in an aqueous medium of (c) one or more stabilizers and (d) one or more monovalent salts. More particularly, it relates to aqueous dispersion compositions comprising from 8 to 28 wt. %, as solids in total of each of the one or more cellulose ethers and the one or more monovalent salts.

Dry mix additives, such as polysaccharides, like gums and cellulose derivatives or cellulose ethers, can provide a shelf stable powder that can be combined in small amounts with dry mix cements on site. However, the amount of dry mix additives used relative to the amount of cement powder in the dry mix is very small and hard to measure. In addition, the introduction of dry mix materials to water is at best sluggish, involving polymer activation and unwinding, which may take days, rather than simple dissolution. Thus, attempts to just add on site a dry mix cellulose ether, for example, may not enable users to benefit properly from their use. This is particularly important where a wet cement composition, such as a low or zero slump concrete pavement mixture is formed using a pug mill, where a conveyor belt moves solids, such as granular materials, into the mill, the cement powder is dispensed overhead and a liquid delivery system adds liquid admixtures into the pug mill. Because cellulose ethers are powdery solids, they can be blown away from the solid delivery conveyor belt by the wind before they are added to the pug mill. Alternatively, in a conventional ready-mix concrete plant, the liquid admixtures are pumped to a mixing chamber, thereby avoiding addition of dry additives; however, a separate admixture for each of a superplasticizer and a cellulose ether would be needed; and, further, use of sufficiently small quantities of dry cellulose ether for direct mixing into large volumes of wet cement entails a labor intensive and technically challenging dosage regimen. In addition, use of large volumes of premixed dry mixes, such as those sold in bags, is impracticable. Therefore, an alternative delivery approach is needed for using cellulose ethers on site. For this and other reasons, admixtures for conventional pavement and many industrial cement applications, such as infrastructure, commercial buildings and oil and gas wells, are often delivered in liquid form. However, where water is scarce or where needs dictate reduced water use, there remains a need to include water reducers or superplasticizers in liquid admixtures.

There are no currently commercially available liquid admixture products that combine water soluble cellulose ethers with superplasticizers or water reducers at suitable-for-use ratios of cellulose ether to superplasticizer. The combination of polysaccharides and superplasticizers, such as polycarboxylate ether (PCE) solutions or a suspension of a poly(melamine sulfonate) formaldehyde or poly(naphthalene sulfonate) formaldehyde condensate, will separate upon standing overnight.

U.S. Pat. No. 6,576,048 B1 to Burdick et al., discloses alkali and ammonium salt solutions that enable provision of 15+wt. % suspensions of cellulose ethers, such as methyl hydroxypropyl cellulose ether (MHPC) and, further, add a viscosity modifying agent to stabilize the dispersion against separation for at least 3 hours. The pourable, high solids suspensions are somewhat stable to separation over a short period time. However, Burdick et al. disclose that salt levels at 20 wt. % or above can cause “performance decay” in tape joint compound formulations even where the suspensions are used at 0.5 wt. % or less of wet mix compositions. Further, Burdick et al. only disclose pourable compositions having suitable amounts of cellulose ethers that have a bulk density of 0.30 g/ml or greater. Still further, Burdick et al. fail to disclose compositions comprising one or more superplasticizers.

In accordance with the present invention, the present inventors have solved the problem of providing pourable, storage stable liquid admixtures comprising one or more cellulose ethers and one or more superplasticizers in an amount suitable for ready, on site use with a cementitious dry mix and water.

### STATEMENT OF THE INVENTION

In accordance with the present invention, a pourable aqueous dispersion composition comprises:
(a) from 8 to 28 wt. % or, preferably, from 12 to 23 wt. %, or, more preferably, from 14 to 23 wt. %, as solids of one or more cellulose ethers, such as a hydroxyalkyl alkylcellulose, preferably, hydroxyethyl methylcellulose, or a cellulose ether containing one or more polyether groups;
(b) from 0.5 to 5 wt. % or, preferably, from 1 to 3 wt. %, as solids of one or more superplasticizers, preferably, a polycarboxylate ether;
(c) in colloidal dispersion form from 0.02 to 0.75 wt. % or, preferably, from 0.075 to 0.55 wt. %, or, more preferably, from 0.15 to 0.3 wt. %, as solids of one or more stabilizers, such as a colloidal stabilizer or a biopolymer, preferably, a polysaccharide; or, more preferably, cellulose ethers containing water soluble functional groups, for example, hydroxyl or carboxyl(ate) groups, such as hydroxyethylcellulose ethers, or carboxymethylcellulose ethers or gums, such as diutan gum Brunei gum, Dingyou gum, guar gum, welan gum, or xanthan gum; and,
(d) in aqueous solution, from 8 to 28 wt. % or, preferably, from 12 to 23 wt. %, as solids of one or more ammonium salts, alkali metal salts, salts of a monovalent nitrogenous base, or a mixture of two or more thereof, preferably, a sodium or potassium salt of a carboxylic acid, such as sodium formate;
wherein the remainder of the composition comprises water, all wt. % s based on the total weight of the aqueous dispersion composition, and all wt. % s add up to 100 wt. %. Preferably, the aqueous dispersion compositions are stable when left undisturbed on a level surface at from 22 to 24° C. and visually inspected for sedimentation or separation for 1 day or more, or, preferably, 6 days or more, or, more preferably, 30 days or more, or, even more preferably, 3 months or more.

Preferably, in accordance with the aqueous dispersion compositions of the present invention, the (a) one or more cellulose ethers is a mixed cellulose ether having both alkyl and hydroxy alkyl ether groups or a mixed cellulose ether having both alkyl and hydroxy alkyl ether groups and one or more polyether groups, such as, more preferably, polyoxyethylene groups. The polyether groups may comprise any of sidechains, crosslinks, or sidechains and crosslinks.

Preferably, in accordance with the aqueous dispersion compositions of the present invention, the (b) one or more superplasticizers is chosen from a polycarboxylate ether containing, naphthalene sulfonate containing, lignosulfonate containing superplasticizers, or mixtures thereof.

In accordance with the present invention, the solids weight ratio of the (a) one or more cellulose ethers and the (d) one or more ammonium salts, alkali metal salts, salts of a monovalent nitrogenous base, or a mixture thereof may range from 0.7:1.0 to 1.4:1 or, preferably, from 0.71:1 to 1.3:1, or, more preferably, from 0.71:1 to 1.2:1.

In another aspect, methods of making the aqueous dispersion compositions in accordance with the present invention comprise:
A. combining the (d) one or more ammonium salts, alkali metal salts, salts of a monovalent nitrogenous base, or a mixture of two or more thereof with the colloidal aqueous dispersion under shear or agitation with water or with a colloidal aqueous dispersion formed by combining the water with (c) one or more stabilizers under shear or agitation, such as for a period of from 4 to 60 minutes, to dissolve the one or more salts and form an aqueous solution; and, then,
B. dispersing into the aqueous solution under shear or agitation, such as from 300 to 8000 rpm for a period of from 2 to 60 minutes, to form an aqueous dispersion:
(i) in any order, the (a) one or more cellulose ethers, the (b) one or more superplasticizers, and, if in the A) combining the resulting aqueous solution does not comprise a colloidal aqueous dispersion of the (c) one or more stabilizers;
(ii) a mixture of the (a) one or more cellulose ethers and the (b) one or more superplasticizers, followed, if in the A) combining the resulting aqueous solution does not comprise a colloidal aqueous dispersion of by the (c) one or more stabilizers; or,
(iii) a mixture of all of the (a) one or more cellulose ethers, the (b) one or more superplasticizers, and, if in the A) combining the resulting aqueous solution does not comprise a colloidal aqueous dispersion of the (c) one or more stabilizers.

In yet another aspect in accordance with the present invention, methods of using the aqueous dispersion compositions to form wet cement compositions comprise:
combining the aqueous dispersion composition with water in a weight ratio of the aqueous dispersion composition to water of from 1:5 to 1:250, or up to 90:1 to form a dilute admixture; and,
combining the dilute admixture with cement, limestone, and sand or aggregate, preferably, a graded aggregate of a fine aggregate, which may include sand, and a coarse aggregate, to reach a total amount, as solids of (a) one or more cellulose ethers of from 0.01 to 0.1 wt. % or, preferably, from 0.012 to 0.085 wt. %, or, more preferably, from 0.015 to 0.07 wt. %, based on the total weight of the wet cement composition. The amount of water combined with the aqueous dispersion composition to form a dilute liquid admixture, stated as a weight ratio of water to the aqueous dispersion composition may range from 5:1 to 250:1, or up to 90:1.

### DETAILED DESCRIPTION OF THE INVENTION

In accordance with the present invention, pourable aqueous dispersion compositions high in cellulose ether solids and comprising remain stable to separation for at least 1 day, or, preferably, at least 30 days. The aqueous dispersion compositions comprise an aqueous solution of (d) one or more ammonium salts, alkali metal salts, salts of a monovalent nitrogenous base, or a mixture thereof, and a colloidal dispersion of (c) one or more stabilizers. The aqueous dispersion compositions provide pourable liquid admixtures for use in cement applications in the field, for example, in roller compacted concrete (RCC) pavement, extrusion or 3-D printing applications, making it easier for dry mix producers and pug mill users to deliver cellulose ethers and superplasticizers into final wet cement formulations. Before the present invention, as cellulose ethers cause thickening when dissolved in water, simply dissolving a cellulose ether in combination with a superplasticizer does not present an attractive option for providing a liquid admixture. To achieve a pourable or pumpable solution, the cellulose ether could only, at maximum, be added at 2 wt. % solids to water, and a superplasticizer would be added preferentially at 0.2 to 0.5 wt. % solids. A liquid formulation with such low levels of cellulose ether would require addition of an infeasibly large volume of admixture to an RCC mixture formulation. Thus, the compositions of the present invention enable proportioning of cellulose ethers in combination with superplasticizers at specifically desired use levels after dilution with water. When used on site, the aqueous dispersion compositions of the present invention enable the cellulose ether and superplasticizer to work the same as they do in powder dry mixes. In the RCC application, where wet cements appear granular, the aqueous dispersion compositions of the present invention enable the provision of wet cements having desirable compaction, yield strength, and lubricity. Such compositions thereby improve the strength and smoothness of pavement made with RCC cements. Likewise, the aqueous compositions in accordance with the present invention facilitate the onsite use of, 3-D printed cements having low or no slump.

The singular forms “a,” “an,” and “the” include plural referents unless the context clearly dictates otherwise. Unless defined otherwise, the terms used herein have the same meaning as is commonly understood by one skilled in the art.

Unless otherwise indicated, any term containing parentheses refers, alternatively, to the whole term as if no parentheses were present and the same term without that contained in the parentheses, and combinations of each alternative. Thus, the term “(meth)acrylate” encompasses, in the alternative, methacrylate, or acrylate, or mixtures thereof.

The endpoints of all ranges directed to the same component or property are inclusive of the endpoint and are independently combinable. Thus, for example, a disclosed solids weight ratio of the (a) one or more cellulose ethers and the (d) one or more ammonium salts, alkali metal salts, salts of a monovalent nitrogenous base, or a mixture thereof of from 0.7:1 to 1.4:1 or, preferably, from 0.71:1 to 1.2:1 means any or all ranges of from 0.7:1 to 1.4:1, or, from 0.7:1 to 1.2:1 or, from 0.71:1 to 1.4:1, or, preferably, from 0.71:1 to 1.2:1.

Unless otherwise indicated, conditions of temperature and pressure are room temperature (23° C.) and standard pressure (101.3 kPa), also referred to as “ambient conditions”. And, unless otherwise indicated, all conditions include a relative humidity (RH) of 50%.

As used herein, the term “acrylic or vinyl” refers to addition polymerizable monomers or addition polymers of α, β-ethylenically unsaturated monomers, such as, for example, alkyl and hydroxyalkyl (meth)acrylates, vinyl ethers, ethylenically unsaturated carboxylic acids, alkyl (meth)acrylamides, or oxyalkylene chain group containing monomers, such as, for example, methoxy poly(ethylene glycol) (meth)acrylate (mPEG(M)A) or poly(ethylene glycol) (meth)acrylate (PEG(M)A) and allyl poly(ethylene glycol) (APEG).

As used herein, the term “admixture” means the ingredients in cement compositions other than cement, limestone, water, and aggregate that are added to the mix immediately before or during mixing.

As used herein the term “aqueous” means that the continuous phase or medium is water and from 0 to 10 wt. %, based on the weight of the medium, of water-miscible compound(s). Preferably, “aqueous” means water.

As used herein, the term “ASTM” refers to publications of ASTM International, West Conshohocken, PA.

As used herein, the term “colloidal” or “colloidal dispersion form” refers to a stabilizer dispersed in water that is activated or in homogeneous mixture in which the stabilizer does not settle out; the stabilizer domains are microscopic or at least invisible to the naked eye. The (c) one or more stabilizers in accordance with the present invention comprise colloids in the aqueous dispersion composition formed in water without salt, whereas the (a) one or more cellulose ethers in the aqueous dispersion compositions have a granular form, a particle or agglomerate size of greater than 1 μm, and would readily settle out of the aqueous solution of the (d) one or more ammonium salts, alkali metal salts, or salts of a monovalent nitrogenous base upon combination therewith.

As used herein the term “dry mix” or “dry powder” means a storage stable powder containing cement, cellulose ether, any other polymeric additive, and any fillers and dry additives. No water is present in a dry mix; hence it is storage stable.

As used herein, the term “hydraulic cement” or “cement” includes substances which set and harden in the presence of water such as Portland cement, silicate-containing cements, aluminate-based or aluminous cements, pozzolanic cements, and calcium aluminosilicate compositions, and composite cements.

As used herein the term “DS” is the mean number of alkyl substituted OH-groups per anhydroglucose unit in a cellulose ether; the term “MS” is the mean number of hydroxyalkyl substituted OH-groups per anhydroglucose unit, as determined by the Zeisel method. The term “Zeisel method” refers to the Zeisel Cleavage procedure for determination of MS and DS, see G. Bartelmus and R. Ketterer, Fresenius Zeitschrift fuer Analytische Chemie, Vol. 286 (1977, Springer, Berlin, DE), pages 161 to 190.

As used herein, the term “lubricity” refers to the slope of a yield curve, expressed as an angle of the linearized yield locus plot measured by shear testing in accordance with ASTM D6773-16 (Standard Test Method for Bulk Solids Using Schulze Ring Shear Tester, 2016) using an automated shear tester controlled by the software RSTCONTROL 95 for MS Windows (Dietmar Schulze, Wolfenbuttel, DE), with 50,000 Pa as the given pre-shear stress. Lubricity measures the ability of particles to move against one another under shear and a lower relative normal force and a lower slope is better. In other words, a lower “internal friction” angle means higher lubricity, as internal friction is the ratio of the maximum internal shear force that resists movement between the particles of a material to a normal force (compaction) between the particles, or the resistance of the particles to moving against each other under compaction and shear.

As used herein, unless otherwise indicated, the phrase “polymer” includes both homopolymers and copolymers from two or more than two differing monomers, as well as segmented and block copolymers.

As used herein, the term “pourable” means a given aqueous dispersion has a viscosity of less than 7,000 cP (Brookfield), contains no visible gel or sediment, and can be readily dispensed without obstruction or blocking using a pipet having an approximate inner diameter of 3 mm. The term “pourable” therefore means both pourable and pumpable.

As used herein, the term “sieve particle size” of a material refers to a particle size as determined by sieving the material through successively smaller size mesh sieves until at least 10 wt. % of the material is retained on a given sieve and recording the size of the sieve that is one sieve size larger than the first sieve which retains at least 10 wt. % of the material.

As used herein the term “sieve particle size of total coarse aggregate” for a mixture of coarse aggregates means the weighted average of the sieve particle sizes of all coarse aggregates in the mixture. For example, the sieve particle size of a 50:50 w/w mix of a 1 mm sieve particle size coarse aggregate and a 10 mm sieve particle size coarse aggregate is (1 mm×0.5)+(10 mm×0.5) or 5.5 mm.

As used herein, the term “slump” refers to the lateral or downward flow of a standing sample of a wet cement composition over a given time period that can be measured in several ways, for example, as determined in accordance with ASTM C143 (2010).

As used herein, the term “storage stable” means that, for a given powder additive composition, the powder will not block and, for a given aqueous composition, the liquid composition will not separate or precipitate after 1 day, or, preferably, 6 days or longer, or, preferably, 30 days or longer when allowed to stand on a shelf under room temperature conditions and standard pressure.

As used herein, the phrase “total solids”, “solids” or “as solids” refers to total amounts of any or all of the non-volatile ingredients or materials present in a given composition, including synthetic polymers, monomers, natural polymers, acids, defoamers, hydraulic cement, fillers, inorganic materials, and other non-volatile materials and additives, such as initiators, regardless of its physical state. Dry mix materials and powders are considered to be solids. Water, ammonia, and volatile solvents are not considered to be solids.

As used herein, the term “viscosity modifying additive” means any thickener, rheology modifier or water activated polymer which increases the viscosity of an aqueous composition.

As used herein, unless otherwise indicated, the term “wt. %” means weight percent based on the indicated denominator.

In accordance with the present invention, pourable aqueous dispersion compositions provide cellulose ether and superplasticizer within a certain compositional range suitable for their ready use in wet cement and to keep the cellulose ether “salted out” of solution so that it doesn't build viscosity.

The stable, pourable aqueous dispersion compositions maintain a balance whereby the cellulose ether suspension remains stable but can be made to thicken the composition upon addition of water. Too low a concentration of cellulose ether will render the pourable aqueous dispersion composition impractical to add to the final application, leaving the wet cement in need of more volume of the aqueous dispersion than there is allowed liquid in the wet cement formulation. Too high a concentration of cellulose ether will cause the aqueous dispersion and the wet cement composition to be too viscous to pump. Suitable amounts of the (a) one or more cellulose ethers in the aqueous dispersion compositions may range from 8 to 28 wt. % or, preferably, from 12 to 23 wt. %, as solids, based on the total weight of the aqueous dispersion composition.

Compounds suitable for use as the (a) one or more cellulose ethers of the present invention are not limited based on their bulk density. Bulk density may relate to the hygroscopicity of a given cellulose ether and thus to the amount of bound water in that composition. Accordingly, the pourable aqueous dispersion composition in accordance with the present invention does not require pre-drying of any cellulose ether. Suitable materials useful as the (a) one or more cellulose ethers may include, for example, any of the following:

Methylcellulose cellulose ethers (MC), ethyl cellulose, propyl cellulose, butyl cellulose, hydroxyethyl methylcellulose (HEMC), hydroxypropyl methylcellulose (HPMC), hydroxyethyl cellulose (“NEC”), ethylhydroxyethylcellulose (EHEC), methylethylhydroxyethylcellulose (MEHEC), hydrophobically modified ethylhydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), and sulfoethyl hydroxyethylcelluloses (SEHEC), and any of the foregoing cellulose ethers having one or more polyether groups. Accordingly, at least one of the (c) one or more cellulose ethers preferably has a side chain chosen from at least two of hydroxyethyl, hydroxypropyl, methyl, a polyether group and combinations thereof, or, preferably, hydroxyethyl and methyl. More preferably, the (c) one or more cellulose ethers are mixed cellulose ethers that contain hydroxyalkyl groups and alkyl ether groups, such as those chosen from alkyl hydroxyethyl celluloses, e.g. hydroxyalkyl methylcelluloses like hydroxyalkyl methylcelluloses, for example, hydroxyethyl methylcellulose (HEMC), hydroxypropyl methylcellulose (HPMC), methyl hydroxyethyl hydroxypropylcellulose (MHEHPC), and ethylhydroxyethyl cellulose (EHEC), or, more preferably, those chosen from hydroxyethyl methylcellulose (HEMC), hydroxypropyl methylcellulose (HPMC), methyl hydroxyethyl hydroxypropylcellulose (MHEHPC), ethylhydroxyethyl cellulose (EHEC), or any of the foregoing cellulose ethers that also have one or more polyether groups. The most preferred low viscosity cellulose ether comprises hydroxyethyl methyl cellulose.

In any of the (c) cellulose ethers in accordance with the present invention, the degree of alkyl substitution is described in cellulose ether chemistry by the term “DS”. The DS is the mean number of substituted OH groups per anhydroglucose unit. The degree of methyl substitution may be reported, for example, as DS (methyl) or DS (M). The degree of hydroxy alkyl substitution is described by the term “MS”. The MS is the mean number of moles of etherification reagent which are bound as ether per mol of anhydroglucose unit. Etherification with the etherification reagent ethylene oxide is reported, for example, as MS (hydroxyethyl) or MS (HE). Etherification with the etherification reagent propylene oxide is correspondingly reported as MS (hydroxypropyl) or MS (HP). The side groups are determined using the Zeisel method (reference: G. Bartelmus and R. Ketterer, Fresenius Zeitschrift fuer Analytische Chemie 286 (1977), 161-190).

Preferably, at least one of the one or more cellulose ethers is a hydroxyethyl methyl cellulose ether having a hydroxyethyl content (MS) ranging from 0 and 0.4 or, from 0.01 to 0.4, and a methoxyl content (DS) of from 1.2 to 1.8, or is a hydroxyethyl cellulose having a hydroxyethyl content (MS) of from 1.4 to 2.4, or, preferably, from 1.8 to 2.2.

One suitable cellulose ether is a mixed cellulose ether that has an aqueous solution viscosity at 1 wt. % cellulose ether solids, at 20° C., and a 514 s⁻¹ shear rate ranging from 50 to 750 mPa*s, or, preferably, from 80 to 500 mPa*s, as determined using a strain-controlled rotational rheometer (ARES-G2™, TA Instruments, New Castle, DE) equipped with a Peltier temperature controller, TRIOS™ data acquisition software (TA Instruments) and DIN (Deutsches Institut für Normung e.V. in German meaning German Institute for Standardization) sample fixtures comprising concentric cylinders, and employing a strain rate sweep from 0.03 to 300/s at ten points/decade, and reporting the average of two trials for each cellulose ether composition, wherein the aqueous solution is made by drying a powder of the cellulose ether overnight in a 70° C. vacuum oven, dispersing it into hot water at 70° C., and allowing it to dissolve while cooling with stirring to room temperature and refrigerating (4° C.) it overnight.

Suitable cellulose ethers having one or more polyether groups can be formed in a conventional manner by modifying or crosslinking a cellulose or a cellulose ether, in any order, including by oxyalkylation with polyether containing modifiers, crosslinking with polyether containing crosslinkers, alkylation, and/or hydroxyalkylation in a manner known in the art, such as is disclosed in U.S. Pat. No. 10,150,704 or WIPO Publication WO 2020/223040 A1, each to Hild et al. For example, the crosslinking or polyether addition reaction may generally be conducted in the process of making a cellulose ether in a reactor in which the cellulose ether itself is made in the presence of caustic or alkali. The process may comprise stepwise addition of reactants to form alkyl ether or hydroxyalkyl ether groups and polyether groups on cellulose. Crosslinking or polyether modification of the cellulose or cellulose ethers may precede one or more addition of alkyl halide, e.g. methyl chloride, in the presence of alkali to form alkyl ethers of the cellulose. The cellulose may preferably be alkalized or activated with alkali before any modification to form cellulose ether or cellulose having polyether groups. Known polyether containing modifiers or crosslinkers may include any having one or more or crosslinking agents having two or more, preferably, two crosslinking groups chosen from halogen groups, glycidyl groups, epoxy groups, and ethylenically unsaturated groups, e.g. vinyl groups, that form ether bonds with the cellulose ether in modifying or crosslinking the cellulose ether, for example, chloro or 1,2-dichloro (poly)alkoxy ethers, e.g. dichloropolyoxyethylene; glycidyl or diglycidyl polyalkoxyethers, e.g. diglycidyl polyoxypropylene; glycidyl(poly)oxyalkyl methacrylate; diglycidyl phosphonates; or vinyl or divinyl polyoxyalkylenes containing a sulphone group. Preferably, the modifier is a glycidyl or diglycidyl polyalkoxyether wherein the polyalkoxyether containing from 4 to 50, or from 5 to 30 or from 6 to 25 oxyalkylene groups, or, more preferably, containing oxyethylene or oxypropylene groups.

In accordance with the pourable aqueous dispersion composition of the present invention, the compositions further comprise (b) one or more superplasticizers, preferably, a polycarboxylate ether.

As is the case with the (a) one or more cellulose ethers, the proper amount of the (b) one or more superplasticizers strikes a balance between feasibility and performance. Superplasticizers can cause gelation in the aqueous dispersion compositions but are present in amounts sufficient to enhance the performance of the (a) one or more cellulose ethers in wet cement applications. While use of too much superplasticizer (SP) may detrimentally effect yield strength when combined with a cellulose ether in an RCC application, use of too little does not change the strength or lubricity of concrete made from the wet cement compositions containing them. Suitable superplasticizer concentrations range high enough that, for example, a 1:20 dilution of the aqueous dispersion compositions and water will provide an amount, as solids of from 0.1 to 0.5 wt. %, based on the total weight of the wet cement composition of polycarboxylate superplasticizers, or, in the case of naphthalene sulfonate and lignosulfonate superplasticizers at least 0.2 wt. %.

Suitable amounts of the (b) one or more superplasticizers may range from 0.5 to 5 wt. % or, preferably, from 1 to 3 wt. %, as solids, based on the total weight of the aqueous dispersion composition.

Any natural polymer stabilizer may be used as the (c) one or more stabilizers in accordance with the present invention. Suitable stabilizers may include any colloidal stabilizer or biopolymer that can be activated under shear in water, for example, a polysaccharide or a cellulosic. Preferred stabilizers may be chosen from polysaccharides, such as gums, starch ethers, and cellulose ethers containing water soluble functional groups, for example, hydroxyl or carboxyl(ate) groups. Examples of cellulose ethers containing water soluble functional groups may include, for example, hydroxyethylcellulose ethers, or carboxymethylcellulose ethers. Examples of gums may include, for example, diutan gum Brunei gum, Dingyou gum, guar gum, or xanthan gum.

The (c) one or more stabilizers in accordance with the present invention are present in amounts high enough that the pourable aqueous dispersion composition remains stable over time, without causing the pourable aqueous dispersion composition to be too viscous to pump or pour. In general, the total amount of the (c) one or more stabilizers may range from 0.02 to 0.75 wt. % or, preferably, from 0.075 to 0.55 wt. %, or, more preferably, from 0.15 to 0.3 wt. %, as solids of stabilizer, based on the total weight of the aqueous dispersion composition.

The (d) one or more ammonium salts, alkali metal salts, or salts of a monovalent nitrogenous base in accordance with the present invention may be any such salt, such as a (poly)carboxylic acid salt or in inorganic acid salt, like guanidine chloride or ammonium sulfate. More preferred are sodium or potassium salts of lower alkanoic acids, like sodium formate, or fugitive base salts, like ammonium salts.

Suitable amounts of the (d) one or more ammonium salts, alkali metal salts, salts of a monovalent nitrogenous base, or a mixture of two or more thereof strike a balance between effective suspension of the (a) one or more cellulose ethers and the need for the pourable aqueous dispersion composition to improve application performance in a wet cement. Too low a salt concentration will cause the pourable aqueous dispersion composition to be too viscous to pump. Suitable amounts of the (d) one or more ammonium salts, alkali metal salts, salts of a monovalent nitrogenous base, or a mixture thereof may range from 8 to 28 wt. % or, preferably, from 12 to 23 wt. %, as solids based on the total weight of the aqueous dispersion composition.

Methods to make the pourable aqueous dispersion compositions in accordance with the present invention may comprise dissolving the (d) one or more ammonium salts, alkali metal salts, or salts of a monovalent nitrogenous base in water to form an aqueous solution, and then, in any order, adding one or more of the (a) one or more cellulose ethers, the (b) one or more superplasticizers, and (c) the one or more stabilizers, or a mixture thereof to the aqueous sodium solution slowly until the blend appears to be wet and evenly dispersed.

The methods of making the aqueous dispersion compositions may also comprise combining (c) one or more stabilizers and water are combined under shear or agitation to activate or colloidally disperse the stabilizer, such as until the viscosity of the composition rises and then stops rising. Such mixing can take place at room temperature and involves, for example, stirring at from 15 to 400 rpm, or, by hand, for from 4 to 60 minutes. Once a colloidal aqueous dispersion of the (c) one or more stabilizers has been formed, the methods may comprise combining under shear or agitation (d) one or more ammonium salts, alkali metal salts, salts of a monovalent nitrogenous base, or a mixture thereof with the colloidal aqueous dispersion to dissolve the salt and form an aqueous solution. Once the salt is dissolved, the methods comprise dispersing each of the (a) one or more cellulose ethers and the (b) one or more superplasticizers into the aqueous dispersion.

In an alternative method, the aqueous solution of the (d) one or more salts or the colloidal aqueous dispersion comprising the (d) one or more salts and the (c) one or more stabilizers can be heated to a temperature of from 40 to 95° C., or, 50° C. or higher, or, 60° C. or higher, or, 70° C. or higher, for example, up to 80° C., and the (a) one or more cellulose ethers can be added, followed by the (b) one or more superplasticizers.

The pourable aqueous dispersion compositions of the present invention find use in various wet cement applications, including roller compacted concrete (RCC), extrusion applications, 3-D printing, mortars, and renders. Preferably, as the pourable aqueous dispersion compositions enable the provision of liquid admixtures in low water content cements, the pourable aqueous dispersion compositions find use in low or zero slump cement applications, such as RCC or 3-D printing.

One suitable RCC dry mix composition for use with the aqueous dispersion compositions of the present invention comprises:
(e) cement, for example, ordinary Portland cement, aluminate cement, fly ash, pozzolans, and their mixtures, in the amount of from 10 to 23 wt. % or, preferably, from 12 to less than 20 wt. %, based on the total weight of the dry mix composition,
(f) graded aggregate in the amount of from 76 to 89.99 wt. % or, preferably, in the amount of from 79.70 to 87.95 wt. %, based on the total weight of the dry mix composition comprising
i) one or more coarse aggregates having a sieve particle size of from 300 μm to 20 mm or, preferably, from 1 to 18 mm, for example, sand, limestone, gravel, granite, or clay, or, preferably sand or gravel, or, preferably, a combination of A) a first coarse aggregate and B) a second coarse aggregate wherein the first coarse aggregate has a sieve particle size of from 300 μm to 3000 μm, and the second coarse aggregate has a sieve particle size of from 2000 μm to 20 mm, or, from 3000 μm to 20 mm, or up to 18 mm, wherein a ratio of the sieve particle size of the second coarse aggregate to that of the first coarse aggregate ranges from 15:1 to 1.5:1, or, preferably from 10:1 to 2:1, and
ii) one or more fine aggregates, preferably limestone or sand, having a sieve particle size of from 40 to less than 300 μm or, preferably, from 70 to less than 300 μm,
wherein all wt. % s add up to 100%.

Preferably, in the RCC dry mix compositions, the weight ratio of the total i) coarse aggregate to the total ii) fine aggregate in the graded aggregate may range from 4:1 to 0.9:1, or, preferably, from 3:1 to 1:1.

The total amount of water from all sources in wet cement compositions for use in RCC applications does not exceed 15 wt. % or, preferably, is 13 wt. % or less, based on the total weight of the wet cement composition.

In accordance with the present invention, the (e) one or more cements or hydraulic cements refers to any hydraulic cement that sets and hardens in the presence of water. Suitable non-limiting examples of hydraulic cements include Portland cement, hydraulic hydrated lime, aluminate cements, such as calcium aluminate cement, calcium sulfoaluminate cement, calcium sulfate hemi-hydrate cement; pozzolans, which are siliceous or aluminosiliceous material with slaked lime that in finely divided form in the presence of water, chemically react with the calcium hydroxide released by the hydration of Portland cement to form materials with cementitious properties, such as diatomaceous earth, opaline cherts, clays, shales, fly ash, silica fume, volcanic tuffs and pumicites, for example, volcanic ash mixed with slaked lime; refractory cements, such as ground granulated blast furnace slag; magnesia cements, such as magnesium phosphate cement, magnesium potassium phosphate cement, and mixtures thereof. Portland cement, as used in the trade, means a hydraulic cement produced by pulverizing and calcining together a clinker, comprising of hydraulic calcium silicates, calcium aluminates, and calcium ferroaluminates, with one or more of the forms of calcium sulfate in an intergrind addition. Portland cements according to ASTM C150 are classified as types I, II, III, IV, or V. Suitable (e) cements may be chosen from, for example, an ordinary Portland cement, an aluminate cement, a pozzolan, or their mixtures, or, preferably, an ordinary Portland cement, an aluminate cement, or a mixture thereof.

Suitable (f) graded aggregate materials include but are not limited to sand, limestone, gravel, granite, and clay and comprise a graded aggregate of i) at least one coarse aggregate and ii) at least one fine aggregate. Smaller ii) fine aggregate particles mixed with i) larger coarse aggregate particles, such as compositions with more than one particle size distribution, reduce void volume and thereby reduce cement demand, and enable improved packing and thus higher strength with less water added at a constant water-to-cement ratio. Suitable ii) fine aggregates are materials that have a sieve particle size of, for example, less than 300 μm, such as limestone, finely divided silica, talc, fillers, or pigments. Suitable i) coarse aggregates have a sieve particle size of 300 μm or larger, and may include, for example, silica, quartz, crushed round marble, glass spheres, granite, coarse limestone, calcite, feldspar, alluvial sands, or any other durable aggregate natural or manufactured sand, and mixtures thereof.

Suitable RCC wet cement compositions for use with the pourable aqueous dispersion composition of the present invention have a slump of 6 mm or less or, preferably, 4.5 mm or less, as determined in accordance with ASTM C143 (2010) using a stainless steel cone height 80 mm, top diameter 40 mm, bottom diameter 90 mm, steel rod stirrer, preferably, of 9.5 mm diameter and 266.7 mm length, by mixing the dry mix compositions in a plastic bag, adding the powder to the indicated amount of water in a Hobart mixing bowl, mixing twice on speed 1 for 15 s and stopping after mixing each time to scrape the sides of the bowl, slaking the mixture for 10 minutes and pouring the mixture in three equal layers into the stainless-steel cone which has been dampened with water via a sponge and placed on a non-absorbent surface, filling each equal layer and mixing with the stainless steel rod in a circular motion, positioning the rod parallel to the sides of the cone and working to a vertical position to finish in the center, finishing the surface of the wet cement composition flush with the top of the cone, pulling the cone up and off of the wet cement composition and recording the slump within 30 seconds by measuring the total height of the cone and reporting the difference in the measured height and 80 mm.

In accordance with the present invention, the lubricity and strength of wet cement products, for example, roller compacted granular wet cementitious compositions can be improved by combining the pourable aqueous dispersion compositions with them so that the total amount of water in the wet cement is 15 wt. % or less or is, preferably, 13 wt. % or less, based on the total weight of the wet cement composition. While the wet cement compositions in accordance with the present invention exhibit a zero slump or nearly zero slump, the high aggregate and low water content in the wet cement compositions also conventionally has caused them to be very resistant to compaction, making the product rougher relative to traditional concrete pavements. Accordingly, the aqueous compositions of the present invention provide a solution to the problem of providing low water loading in wet cement compositions that do not exhibit excessive roughness when finished.

The wet cement compositions comprising the pourable aqueous dispersion compositions in accordance with the present invention have a lubricity of from 22° to 37° or less, or, preferably, from 26° to 36°, determined as the angle of the slope of a yield curve of the normal stress at which the compositions yield in shear testing plotted versus the normal stress (on the abscissa), wherein the normal stress is varied from 25% to 80% of a pre-shear normal stress in accordance with ASTM D6773-16 (2016), preferably, using an automated shear tester controlled by the software RSTCONTROL 95 for MS Windows (Dietmar Schulze, Wolfenbottel, DE), and using 50,000 Pa as the pre-shear normal stress and then reducing normal stress and measuring over a normal stress range of from 12,500 Pa to at least 40,000 Pa with a point spacing of 5 points per decade of % of pre-shear normal stress.

The wet cement compositions of the present invention can contain, in addition to the cement, graded aggregate and the pourable aqueous dispersion composition, conventional additives in wet or dry form, such as, for example, cement setting accelerators and retarders, air entrainment agents or defoamers, shrinking agents and wetting agents; surfactants, particularly nonionic surfactants; mineral oil dust suppressing agents; biocides; plasticizers; organosilanes; anti-foaming agents such as poly(dimethylpolysiloxanes) (PDMS) and emulsified PDMS, silicone oils and ethoxylated nonionics; and coupling agents such as, epoxy silanes, vinyl silanes and hydrophobic silanes.

The present invention discloses and relates to the following clauses:

CLAUSE 1. A pourable aqueous dispersion composition comprising:
(a) from 8 to 28 wt. % or, preferably, from 12 to 23 wt. %, as solids of one or more cellulose ethers, or, preferably, a hydroxyalkyl alkylcellulose or a cellulose ether containing one or more polyether groups;
(b) from 0.5 to 5 wt. % or, preferably, from 1 to 3 wt. %, as solids of one or more superplasticizers, preferably, a polycarboxylate ether;
(c) in colloidal dispersion form from 0.02 to 0.75 wt. % or, preferably, from 0.075 to 0.55 wt. %, or, more preferably, from 0.15 to 0.3 wt. %, as solids of one or more stabilizers, chosen from a colloidal stabilizer or a biopolymer; and,
(d) in aqueous solution, from 8 to 28 wt. % or, preferably, from 12 to 23 wt. %, as solids of one or more ammonium salts, alkali metal salts, salts of a monovalent nitrogenous base, or a mixture of two or more thereof, preferably, a sodium or potassium salt of a carboxylic acid;
wherein the remainder of the composition comprises water, all wt. % s based on the total weight of the aqueous dispersion composition, and all wt. % s add up to 100 wt. %.

2. The pourable aqueous dispersion composition as set forth in item 1, wherein the aqueous dispersion composition is stable for 6 days or more, or, more preferably, 30 days or more, or, even more preferably, 3 months or more when left undisturbed on a level surface at from 22 to 24° C. and visually inspected for sedimentation or separation.

3. The pourable aqueous dispersion composition as set forth in any one of items 1 or 2, above, wherein the (a) one or more cellulose ethers is a mixed cellulose ether having both alkyl and hydroxy alkyl ether groups or a mixed cellulose ether having both alkyl and hydroxy alkyl ether groups and one or more polyether groups.

4. The pourable aqueous dispersion composition as set forth in any one of items 1, 2 or 3, above, wherein, the solids weight ratio of the (a) one or more cellulose ethers and the (d) one or more ammonium salts, alkali metal salts, salts of a monovalent nitrogenous base, or a mixture thereof ranges from 0.7:1.0 to 1.4:1 or, preferably, from 0.71:1 to 1.3:1, or, more preferably, from 0.71:1 to 1.2:1.

5. A method of making the pourable aqueous dispersion composition as set forth in any one of items 1, 2, 3 or 4, above, comprising:
A) combining the (d) one or more ammonium salts, alkali metal salts, salts of a monovalent nitrogenous base, or a mixture thereof with water, such as water at a temperature of from 40 to 80° C., or with a colloidal aqueous dispersion formed by combining the water with (c) one or more stabilizers under shear or agitation, such as for a period of from 4 to 60 minutes, to dissolve the one or more salts and form an aqueous solution; and, then,
B) dispersing into the aqueous solution under shear or agitation to form an aqueous dispersion:
(i) in any order, the (a) one or more cellulose ethers, the (b) one or more superplasticizers, and, if in the A) combining the resulting aqueous solution does not comprise a colloidal aqueous dispersion of the (c) one or more stabilizers;
(ii) a mixture of the (a) one or more cellulose ethers and the (b) one or more superplasticizers, followed, if in the A) combining the resulting aqueous solution does not comprise a colloidal aqueous dispersion of by the (c) one or more stabilizers; or,
(iii) a mixture of all of the (a) one or more cellulose ethers, the (b) one or more superplasticizers, and, if in the A) combining the resulting aqueous solution does not comprise a colloidal aqueous dispersion of the (c) one or more stabilizers.

6. A method of using the pourable aqueous dispersion composition as set forth in any one of items 1, 2, 3, or 4, above, to form wet cement compositions comprising:
combining the aqueous dispersion composition with water in a weight ratio of the aqueous dispersion composition to water of from 1:5 to 1:250 to form a dilute admixture; and,
combining the dilute admixture with cement, limestone, and sand or aggregate, preferably, a graded aggregate of a fine aggregate and a coarse aggregate, to reach a total amount, as solids of (a) one or more cellulose ethers of from 0.01 to 0.1 wt. % or, preferably, from 0.012 to 0.085 wt. %, or, more preferably, from 0.15 to 0.07 wt. %, based on the total weight of the wet cement composition.

7. The method as set forth in item 6, above, wherein the amount of water combined with the pourable aqueous dispersion composition to form a dilute liquid admixture, stated as a weight ratio of water to the aqueous dispersion composition ranges from 5:1 to 250:1, or, preferably, up to 90:1.

### EXAMPLES

The following examples illustrate the present invention. Unless otherwise indicated, all parts and percentages are by weight and all temperatures are in ° C. and all preparations and test procedures are carried out at ambient conditions of room temperature (23° C.) and pressure (1 atm). In the examples and Tables 1, 2, and 3 that follow, the following abbreviations were used: CE: cellulose ether; DGE: Diglycidyl Ether; EO: Ethylene Oxide; MPEG: Methoxypoly(ethylene glycol); MAA: Methacrylic acid; AA: Acrylic acid; MMA: Methyl methacrylate; PEO: Poly(ethylene oxide); VMA: Viscosity modifying additive.

The following materials were used in the Examples that follow (All components were used as received):
Silica sand: Sieve particle size of 300 μm (Fairmount Minerals 730, Fairmount Minerals LLC, Oklahoma City, OK);
Crushed limestone: CaCO₃, Sieve particle size 44 μm (MICRO-WHITE™ 100, Nagase Specialty Materials NA LLC, Itasca, IL);
Manufactured sand: 6 mm sieve particle size;
Portland cement: Type 1 Portland cement;
Water (deionized);
Cellulose ether 1: Ultra high viscosity Hydroxyethyl methylcellulose (HEMC), (WALOCEL™ M 120-01, The Dow Chemical Co., Midland, MI (Dow), MS=0.27, DS=1.57; 1 mmol EPILOX™ M985 crosslinker per 1 mol anhydroglucose unit, degree of substitution <0.01; 1 wt. % aqueous solution viscosity measured on Haake Viskotester™ VT-550 at 2.55 1/s and 20° C. was 13200 mPa·s);
Cellulose ether 2: Hydroxyethyl methylcellulose (HEMC), WALOCEL™ MW 15000 PFV, Dow, MS=0.17, DS=1.40, viscosity of 1 wt. % aqueous solution viscosity measured on Haake Viskotester™ VT-550 at 2.55 1/s and 20° C. was 972 mPa·s);
Stabilizer A: Diutan Gum natural high-molecular-weight gum produced by aerobic fermentation; KELCOCRETE™ DG-F gum, Cp Kelco Co., Atlanta, GA;
Stabilizer B: Sodium carboxymethylcellulose 700,000 molecular weight, Acros Organics, Thermo Fisher Scientific, Waltham, MA (Fisher);
Stabilizer C: CELLOSIZE™ QP-52000H hydroxymethyl cellulose, Dow;
Superplasticizer 1: MELFLUX™ 2651 F polycarboxylate ether, BASF, Ludwigshafen, DE;
Superplasticizer 2: Sodium or calcium naphthalene sulfonate water reducer (TAMOL™ SN, Dow);
Superplasticizer 3: VISCOCRETE™ 225 P polycarboxylate ether (PCE), Sika Corporation, Lyndhurst, NJ;
Salt 1: Sodium formate, Alfa Aesar, Ward Hill, MA;
Salt 2: Guanidine hydrochloride, Fisher; and,
Salt 3: Sodium sulfate, Fisher.

The following formulation methods to make aqueous dispersion compositions were used in the following Examples 1 to 10 and Comparative

Examples 1C to 15C, below, with only proportions changing as indicated: Formulation of Aqueous Dispersion of Inventive Example 6: 100 g Aqueous dispersions comprising 18 wt. % of sodium formate, 0.125 wt. % of diutan gum, 2 wt. % of a polycarboxylate ether (Superplasticizer 3), and 15 wt. % hydroxyethyl methylcellulose ether (Cellulose ether 2) in water 64.88 wt. % were formed by weighing 64.88 g of water in a container and adding 0.125 g diutan gum while mixing with an overhead mixer at from 4000 to 6000 rpm; and continuing mixing for about 10 min until the mixture appears homogeneous and forms a suspension. Adding 2 g of polycarboxylate ether and 18 g of sodium formate to the suspension and mixing until the salt is completely dissolved and forms a dispersion. Adding slowly 15 g of cellulose ether to the dispersion while mixing; and continuing mixing until the cellulose ether appears to be completely wet and dispersed evenly throughout.

Formulation of Aqueous Dispersion of Comparative Example 15C without a stabilizer: The method of Example 6 was repeated except using 64.5 g water, 14 g sodium formate, 1.5 g of Superplasticizer 3 and 20 g of Cellulose ether to prepare a 100 g dispersion.

Model RCC Wet cement Preparation: The indicated sand, limestone, and cement in Tables 1, were dry mixed in a plastic bag for two minutes, and then added to the indicated aqueous admixture materials comprising cellulosic ether and superplasticizer in all of Tables 1A and 1 B, below and the indicated amount of water in a mixing bowl (Hobart N50 Mixer, Hobart Corp., Troy, OH). Each formulation was mixed at a low rotation rate (136 RPM) for 15 seconds, while mixing bowl sides were scraped off and returned to the bowl bottom. The formulations were mixed at the same rotation rate again for 15 seconds. In all tests, the wet cement compositions were tested within 10 min. after preparation. All compositions totaled 800 g powder solids, where 800 g is 100% dry parts powder. Water wt. % is based on the total formulation weight, which includes powder solids and water. The resulting formulations were then subject to ring shear testing.

TABLE 1A
Example 1A Inventive RCC Wet Cement Composition

| Batch size | Specific density | Wt. | Mass |
|---|---|---|---|
| powders (g) | (g/cm³) | % | (g) |
| Portland cement | 3.17 | 15 | 120 |
| Silica sand | 2.67 | 64 | 512 |
| Crushed limestone | 2.80 | 20 | 160 |
| Cellulose ether | | 1 | 8 |
| dispersion Indicated | | | |
| in Table 2 or 3 | | | |
| Total Parts | | 100 | 800 |
| Water | | | 102.64- |
| | | | 103.12 |
| % water | | | 11.90% |

TABLE 1B
Comparative RCC Wet Cement Composition

| Batch size | Specific density | Wt. | Mass |
|---|---|---|---|
| powders (g) | (g/cm³) | % | (g) |
| Portland cement | 3.17 | 15 | 120 |
| Silica sand | 2.67 | 64.25 | 514 |
| Crushed limestone | 2.80 | 20 | 160 |
| Base on cement | | | |
| 20 wt. % cellulose | | 0.75 | 6 |
| ether dispersion | | | |
| indicated in Table 2 | | | |
| or 3 | | | |
| Total Parts | | 100 | 800 |
| Water | | | 104.19 |
| % water | | | 11.90% |

Test Methods: The following test methods were used in the examples that follow:

Viscosity of Aqueous Dispersions and Pore Solutions: Unless otherwise specified, viscosity, including Initial Brookfield Viscosity of an indicated aqueous composition, was measured after dilution as indicated with water and the measurement was taken at 20° C. using a Brookfield viscometer using LV spindle type LV 4 (64) with rotation speed at 30 RPM. A serial dilution of the indicated aqueous dispersion was performed by adding the tap water to the aqueous dispersion and stirring the mixture with an overhead stirrer at 4000 to 6000 RPM for 2 to 5 minutes.

The Final Brookfield Viscosity refers to an end viscosity of the indicated aqueous composition, as determined after allowing the indicated composition to equilibrate for a period of 72 hours using the same equipment at 20° C. at 0.6 rpm.

Pourable and pumpable viscosity: An aqueous dispersion was considered pourable and pumpable if it had a viscosity of less than 7,000 cP (Brookfield), contained no visible gel or sediment and could be dispensed with a pipet (FISHER™ brand Standard Disposable Transfer Pipettes, Nongraduated; Length:17.92 cm (7″), Fisher Scientific, Waltham, MA) having an approximate inner diameter of 3 mm, without obstruction or blocking.

Stability: The indicated aqueous dispersion was left undisturbed on a level surface at from 22 to 24° C. for the indicated time and inspected for visible sedimentation or separation. Dispersions were considered stable if they dispersion did not visibly separate (sediment) over time when a period of 1 day or more, preferably, 6 days or more, or, more preferably, 30 days or more, or, even more preferably, 3 months or more.

Preparation of a model cement pore solution: Cement pore solutions were formed from the indicated aqueous dispersion composition by dilution with deionized water as indicated, and adding and dissolving salts at the following indicated concentrations. Potassium chloride at 7.1 g/L; sodium chloride at 2.2 g/L; calcium hydroxide at 0.4 g/L.

Ring Shear Testing: Shear testing of the indicated Model RCC compositions was performed in accordance with ASTM D6773-16 (Standard Test Method for Bulk Solids Using Schulze Ring Shear Tester, 2016). An automated shear ring tester, controlled by the software RSTCONTROL 95 for MS Windows (Dietmar Schulze, Wolfenbüttel, DE), was used to measure parameters with 50,000 Pa as the given preshear stress. The indicated wet cement composition samples were loaded into an annular test cell after being slaked for 10 minutes. Each sample weight was recorded. The test cell was then placed into the ring shear tester and the ring shear testing program was initiated. Three parameters were measured to quantify properties of the wet cement compositions: Unconfined yield strength, cohesion, and internal friction angle. Un-confined yield strength or Yield Strength quantifies the strength of a bulk solid under a level of compaction or consolidation in unconfined state (no confining side walls) and was determined as the stress level (normal) that caused the wet cement composition in an unconfined (unsupported) state to yield in response to shear. Internal friction angle (Lubricity), or the ability of particles in the composition to move against one another under shear, was determined as the slope of a yield curve measured by shear testing. Internal friction equals the resistance of the particles to moving against each other under compaction and shear and is the ratio of the maximum internal shear force that resists the movement of the particles to the normal force between the particles. Lubricity was determined as the slope of a yield curve measured by the ring shear tester, wherein the curve plots the maximum internal shear at which the particles resist movement versus normal stress at which the composition is exposed to normal compaction. Lower internal friction means higher lubricity.

TABLE 2
Dispersions From a Variety of Compositions

| | Cellulose ether | | Stabilizer | Superplasticizer | | Salt | | Water | Ratio salt to | Pourable | Stability | |
|---|---|---|---|---|---|---|---|---|---|---|---|---|
| Example | (wt. % solids) | | (wt. % solids) | (wt. % solids) | | (wt. % solids) | | (wt. %) | cellulose ether | (yes/no) | (time) | |
| 1C* | 2 | (20%) | None | 1 | (3.75%) | None | | 76.25% | 0 | No | n/a | |
| 2C* | 2 | (20%) | None | 1 | (3.75%) | 1 | (14%) | 62.25% | 0.7 | No | n/a | |
| 3C* | 2 | (15%) | None | 1 | (1.5%) | 1 | (14%) | 69.5% | 0.93 | No | n/a | |
| 4C* | 2 | (9%) | None | 1 | (2.6%) | 2 | (21%) | 67.4% | 2.3 | No | n/a | |
| 5C* | 2 | (15%) | B (1%) | 3 | (2%) | 1 | (21%) | 61% | 1.4 | No | n/a | |
| 6C* | 2 | (15%) | A (1%) | 3 | (2%) | 1 | (21%) | 61% | 1.4 | No | n/a | |
| 7C* | 2 | (15%) | C (0.75%) | 3 | (2%) | 1 | (15%) | 67.25% | 1.4 | No | n/a | |
| 8C* | 2 | (15%) | C (1%) | 3 | (2%) | 1 | (21%) | 61% | 1.4 | No | n/a | |
| 9C* | 2 | (15%) | None | 1 | (1.5%) | 1 | (17.5%) | 66% | 1.2 | Yes | 1-2 | hours |
| 10C* | 2 | (15%) | None | 1 | (1.5%) | 1 | (28%) | 55.5% | 1.9 | Yes | 1-2 | hours |
| 11C* | 2 | (20%) | None | 1 | (1.5%) | 1 | (28%) | 50.5% | 1.4 | Yes | 1-2 | hours |
| 12C* | 2 | (15%) | None | 2 | (1.5%) | 1 | (14%) | 69.5% | 0.93 | Yes | 1-2 | hours |
| 13C* | 2 | (15%) | None | 1 | (1.5%) | 1 | (14%) | 69.5% | 0.93 | Yes | 1-2 | hours |
| 1 | 2 | (15%) | C 0.25% | 3 | (2%) | 1 | (21%) | 61.75% | 1.4 | Yes | 1 | day |
| 2 | 2 | (15%) | C 0.5% | 3 | (2%) | 1 | (21%) | 61.5% | 1.4 | Yes | 1 | day |
| 3 | 2 | (15%) | A 0.1% | 3 | (2%) | 1 | (12%) | 70.9% | 0.8 | Yes | 3 | Weeks |
| 4 | 2 | (15%) | A 0.05% | 3 | (2%) | 1 | (21%) | 61.95% | 1.4 | Yes | 1 | day |

| | | | | | | | | | | | |
|---|---|---|---|---|---|---|---|---|---|---|---|
| 5 | 1 | (15%) | A 0.2% | 3 | (2%) | 1 | (21%) | 61.8% | 1.4 | Yes | 1 Week (6- |
| | | | | | | | | | | | 8 days) |

*Denotes comparative example.

TABLE 3
Dispersion Performance in a Synthetic Cement Pore Solution and Model RCC Pavement Mix

| | | | | | | | Viscosity | | Model | |
|---|---|---|---|---|---|---|---|---|---|---|
| | | | | | | | Synthetic | | RCC | Model |
| | Cellulose | Superplasticizer | Sodium | Stabilizer | | Pourable | Cement | | Yield | RCC |
| | Ether 2 | 3 | Formate | A | Water | And | Pore | Stability ≥6 | Strength | Lubricity |
| Example | (Weight %) | (Weight %) | (Weight %) | (Weight %) | (Weight %) | Pumpable | Solution | months | (kPa) | (degree) |
| 6 | 15% | 2% | 18% | 0.125% | 64.88% | Yes | 6000 | Yes | 52 | 35.9 |
| 7³ | 15% | 2% | 21% | 0.05% | 61.95% | Yes | 5200 | No | 52 | 36.8 |
| 14C* | 15% | 2% | 15% | 0.05% | 67.95% | No¹ | 2360 | No | Not | Not |
| | | | | | | | | | Measured | Measured |
| 8 | 15% | 2% | 21% | 0.20% | 61.8% | Yes | 6280 | Yes | 57 | 36.3 |
| 9 | 15% | 2% | 15% | 0.20% | 67.8% | Yes | 6060 | Yes | 52 | 36.6 |
| 15C* | 20% | 1.5% | 14% | 0% | 64.5% | No | 720² | n/a | 55 | 36.5 |
| 16C*^{,4} | 15% | 1.5% | 28% | 0% | 55.5% | Yes | Not | no | 59 | 35.2 |
| | | | | | | | measured | | | |

*Denotes comparative example.
¹Gel formed in the viscosity range;
²Pipet was clogged and solids remaining in pipet filtered water and reduced solids in solution as measured;
³Same composition as in Example 4;
⁴This composition is the same as comparative Example 10C. In this example pore solution viscosity was not measured because of its instability, but the composition was subject to shear testing to determine if the higher concentration of salt would impact performance in a formulation.

TABLE 4
Example 8—Aqueous
Dispersion Dilution of The Dispersion of Example

| | | Initial | Final | |
|---|---|---|---|---|
| | % | Brook- | Brookfield | |
| % | Cel- | field | Viscosity | |
| Dis- | lulose | Viscosity | (0.6 RPM | |
| persion | Ether | (cP) | (cP)) | Observations |
| 100% | 15% | 3760 | n/a | Dispersion, solid |
| | | | | particulates |
| 50% | 7.5% | n/a | n/a | Observe solid particulates, |
| | | | | dispersion still partially |
| | | | | intact |
| 31.67% | 4.75% | 8400 | 583000 | No obvious dispersion |
| | | | | present |
| 25% | 3.75% | 820 | 129000 | No obvious dispersion |
| | | | | present |
| 18.8% | 2.8% | 1680 | 50000 | No obvious dispersion |
| | | | | present |

As shown in Tables 2 and 3, above, the present invention has demonstrated formation of pourable and stable aqueous dispersions comprising cellulose ether with a variety of superplasticizers, including both polycarboxylate ether and naphthalene sulfonate polymers in aqueous sodium, ammonium and nitrogenous base salts, including sodium formate, sodium sulfate and guanidine hydrochloride. Aqueous dispersions having one or more cellulose ethers in an amount of 15 wt. % or more were formed from each of diutan gum, carboxymethylcellulose; xanthan gum. Even with 2 wt. % of a superplasticizer, aqueous dispersions of Inventive Examples 1, 2, 3, 4 and 5 exhibit at least 1 day stability in aqueous dispersions having the preferred 0.075 to 0.55 wt. %, as solids of a stabilizer and a range of solids weight ratios of cellulose ether to salt ranging from 0.7:1 to 1.3:1. Further, the aqueous dispersions of Inventive Examples 3 and 5 exhibit at least 6 day stability in aqueous dispersions having the more preferred 0.15 to 0.225 wt. % of a stabilizer and a range of solids weight ratios of cellulose ether to salt ranging from 0.7:1 to 1.3:1. And, even with 2 wt. %, as solids of a superplasticizer, aqueous dispersions of Inventive Examples 6, 8 and 9 exhibit 6 month stability in aqueous dispersions having the preferred 0.075 to 0.55 wt. %, as solids of a stabilizer and a solids weight ratio of cellulose ether to salt ranging from 0.7:1 to 1.15:1. In Examples 7 and 14C, less than 0.075 wt. %, as solids of stabilizer enabled overnight stability but not 6 month stability. Comparative Examples 1C to 4C, 6C, 7C, 9C, 10C, 11C, 12C 13C, 15C and 16C comprised no stabilizer and those of Comparative Examples 5C, 6C, 7C and 8C comprised excess amounts of stabilizer to enable pourable compositions. Meanwhile, Comparative Examples 1C, 2C and 3C had insufficient amounts of salt to stably disperse the cellulose ethers. Further, wet cements made from the inventive compositions of Examples 6, 7, 8 and 9 can be formed into a useful pavement, unlike that of Comparative Example 14C. Comparative Example 15C could be used to form a useful pavement if it could be scooped into a cement composition similar to solids handling. However, as the composition in Comparative Example 15C is not pumpable, it does not make a useful aqueous dispersion composition. Likewise, while the composition in Comparative Example 16C could also form a useful pavement, it is unstable and must be used within 1 to 2 hours of preparing the dispersion and so is not useful in the field.

As shown in Table 4, below, the aqueous dispersion compositions of the present invention enable viscosity modification, thickening and remain stable upon dilution.

1. A pourable aqueous dispersion composition comprising:
(a) from 8 to 28 wt. %, as solids of one or more cellulose ethers;
(b) from 0.5 to 5 wt. %, as solids of one or more superplasticizers;
(c) in colloidal dispersion form from 0.02 to 0.75 wt. %, as solids of one or more stabilizers; and,
(d) in aqueous solution, from 8 to 28 wt. %, as solids of one or more ammonium salts, alkali metal salts, salts of a monovalent nitrogenous base, or a mixture of two or more thereof,
wherein the remainder of the composition comprises water and all wt. % s add up to 100 wt. %.

2. The pourable aqueous dispersion composition as claimed in claim 1, wherein at least one of the (a) one or more cellulose ethers is a hybrid cellulose ether having both alkyl and hydroxy alkyl ether groups or a hybrid cellulose ether having both alkyl and hydroxy alkyl ether groups and one or more polyether groups.

3. The pourable aqueous dispersion composition as claimed in claim 1, wherein at least one of the (a) one or more cellulose ethers is a hydroxyethyl methyl cellulose ether having a hydroxyethyl content (MS) ranging from 0.01 and 0.4, and a methoxyl content (DS) of from 1.2 to 1.8, or is a hydroxyethyl cellulose having a hydroxyethyl content (MS) of from 1.4 to 2.4.

4. The pourable aqueous dispersion composition as claimed in claim 1, wherein the (b) one or more superplasticizers comprises a polycarboxylate ether.

5. The pourable aqueous dispersion composition as claimed in claim 1, wherein the (c) one or more stabilizers comprises a polysaccharide.

6. The pourable aqueous dispersion composition as claimed in claim 5, wherein the (c) one or more stabilizers is chosen from a cellulose ether containing water soluble functional groups, diutan gum, Brunei gum, Dingyou gum, guar gum, welan gum, or xanthan gum.

7. The pourable aqueous dispersion composition as claimed in claim 1, the composition comprising:
(a) from 12 to 23 wt. %, as solids of the one or more cellulose ethers;
(c) from 0.075 to 0.55 wt. %, as solids of the one or more stabilizers; and
(d) from 12 to 28 wt. %, as solids of the one or more ammonium salts, alkali metal salts, salts of a monovalent nitrogenous base, or a mixture of two or more thereof.

8. The pourable aqueous dispersion composition as claimed in claim 1, wherein the composition comprises a solids weight ratio of the (a) one or more cellulose ethers and the (d) one or more ammonium salts, alkali metal salts, salts of a monovalent nitrogenous base, or a mixture thereof in the range of from 0.71:1 to 1.3:1.

9. The pourable aqueous dispersion composition as claimed in claim 1, wherein the aqueous dispersion composition is stable for 30 days or more when left undisturbed on a level surface at from 22 to 24° C. and visually inspected for sedimentation or separation.

10. A method of making a pourable aqueous dispersion composition as claimed in claim 1, comprising:
A) combining the (d) one or more ammonium salts, alkali metal salts, salts of a monovalent nitrogenous base, or a mixture of two or more thereof with water or with a colloidal aqueous dispersion formed by combining the water with (c) one or more stabilizers under shear or agitation to dissolve the one or more salts and form an aqueous solution; and, then,
B) dispersing into the aqueous solution under shear or agitation to form an aqueous dispersion:
(i) in any order, the (a) one or more cellulose ethers, the (b) one or more superplasticizers, and, if in the A) combining the resulting aqueous solution does not comprise a colloidal aqueous dispersion of the (c) one or more stabilizers;
(ii) a mixture of the (a) one or more cellulose ethers and the (b) one or more superplasticizers, followed, if in the A) combining the resulting aqueous solution does not comprise a colloidal aqueous dispersion of by the (c) one or more stabilizers; or,
(iii) a mixture of all of the (a) one or more cellulose ethers, the (b) one or more superplasticizers, and, if in the A) combining the resulting aqueous solution does not comprise a colloidal aqueous dispersion of the (c) one or more stabilizers.
